(19) United States
(12) Patent Application Publication
(10) Pub. No.: US 2007/0291115 A1
(43) Pub. Date: Dec. 20, 2007

(54) REMOTE VIDEO SURVEILLANCE, OBSERVATION, MONITORING AND CONFIRMING SENSOR SYSTEM

(76) Inventors: PAUL W. BACHELDER, Fairfax, VA (US); ANDREW MOYER, Arlington, VA (US); ANDREW C. CERUTTI, Alexandria, VA (US); RICKY E. BOWERS, Stafford, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(21) Appl. No.: 11/425,332

(22) Filed: Jun. 20, 2006

(51) Int. Cl. H04N 7/18

(52) U.S. Cl. 348/143

(57) ABSTRACT

A video surveillance system includes at least one camera module electrically coupled to at least one Mini Intrusion Detection System® (MIDS). Additionally, a base station is electrically coupled to the at least one camera module to provide surveillance, monitoring, observation and confirmation of an item detected by the MIDS.

### GOVERNMENT INTEREST

The invention described herein may be manufactured, used, sold, imported, and/or licensed by or for the Government of the United States of America.

### FIELD OF THE INVENTION

The present invention generally relates to video surveillance monitoring systems, and, more particularly to remote video surveillance, observation, monitoring and confirming sensor systems.

### BACKGROUND OF THE INVENTION

Most video surveillance monitoring systems are designed for use as home or business security systems. These systems are permanently installed by a professional in and around the home or business to be monitored. Some of these systems have day and night cameras. However, these systems' day and night capabilities are limited by ambient light or illumination. Further, these systems have other challenges to making them manportable including a choice of external battery, solar panel or internal rechargeable military grade battery supply requirement, size, nighttime or obscured visibility either with too much or not enough ambient light, limited video RF links through or around urban structures and ease of operation and deployment.

Furthermore, after the evolution of Unattended Ground Sensors (UGS) for perimeter security, there was a need to eliminate false alarms or nuisance alarms. UGS are primarily low power motion detectors such as passive infrared, seismic, magnetic and/or break beam sensors. UGS do not have the ability to decipher what is detected other than to inform an operator that there is some kind of movement detected by the UGS sensor. Video surveillance monitoring systems users have unsuccessfully attempted to confirm the alarm as an intrusion versus a false alarm. For example, several manufactures have integrated cameras to there UGS for a visual confirmation with limited success due to a delay in video transmission. Real time video transmission was rare because of the power requirements for multiple cameras or transmission distance.

Therefore, there is a need for a video surveillance monitoring system that is manportable and provides the capability of surveillance video day or night without any illumination. Additionally, there is a need for a system to be able to switch automatically to an appropriate camera sensing the ambient light conditions. Also, the system needs to be built for all weather conditions without artificial illumination in covert applications. Further, the system's design needs to allow for an ability to change the exterior skin to match the surrounding environment.

In addition to the above, there is a need for a video surveillance monitoring system has cameras that can be in a power save mode and wake up in time to capture an event with the appropriate camera and send an alarm back to a Base Station. There is also a need for the cameras to go back to a power save mode automatically after a pre-set time and turn back ON with detection from the UGS or remotely by the Operator, if desired.

### SUMMARY OF THE INVENTION

It is therefore an object of this invention to make a manportable video surveillance monitoring system. The system could be used, e.g., by the US military, to increase situational awareness providing force protection and security. Special reconnaissance or information gathering would also be a by-product of the system. Other spin-off users will be training facilities to capture and document their exercises.

This and other objects of the invention are achieved in one aspect by a video surveillance system including at least one camera module electrically coupled to at least one Mini Intrusion Detection System® (MIDS). Additionally, a base station is electrically coupled to the at least one camera module to provide surveillance, monitoring, observation and confirmation of an item detected by the MIDS.

Another aspect of the invention involves the at least one camera module is electrically coupled to the at least one MIDS by a wireless network.

To the accomplishment of the foregoing and related ends, the invention provides the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a diagram illustrating a video surveillance system in accordance with an embodiment of the invention.

FIG. 2 is a diagram illustrating a prospective front view of a camera module in accordance with the invention.

FIG. 3 is a diagram illustrating a prospective rear view of the camera module in accordance with the invention.

FIG. 4 is a diagram illustrating a prospective rear view of the camera module opened to show a power control printed wiring board in accordance with the invention.

FIG. 5 is a diagram illustrating a prospective rear view of the camera module opened to show a MIDS receiver in accordance with the invention.

FIG. 6 is a diagram illustrating a prospective front view of the camera module with an anti-reflective filter in accordance with the invention.

FIG. 7 is a diagram illustrating a camera module printed circuit board of a camera module in accordance with the invention.

FIG. 8 is a diagram illustrating a prospective front view of a base station in accordance with the invention.

FIG. 9 is a diagram illustrating a Mini Intrusion Detection System® (MIDS) Remote Control Transmitter and a Hand Held Receiver in accordance with the invention.

FIG. 10 is a diagram illustrating a prospective view of a wireless module in accordance with the invention.

FIG. 11 is a diagram illustrating a Mini Seismic Intrusion Detector (MSID) sensor and a Passive Infrared (IR) Sensor (PIRH) in accordance with the invention.

FIG. 12 is a diagram illustrating a Field Monitor in accordance with the invention.

FIG. 13 is a diagram illustrating a video surveillance system in accordance with another embodiment of the invention.

In the detailed description that follows, identical components have been given the same reference numerals.

### DETAILED DESCRIPTION

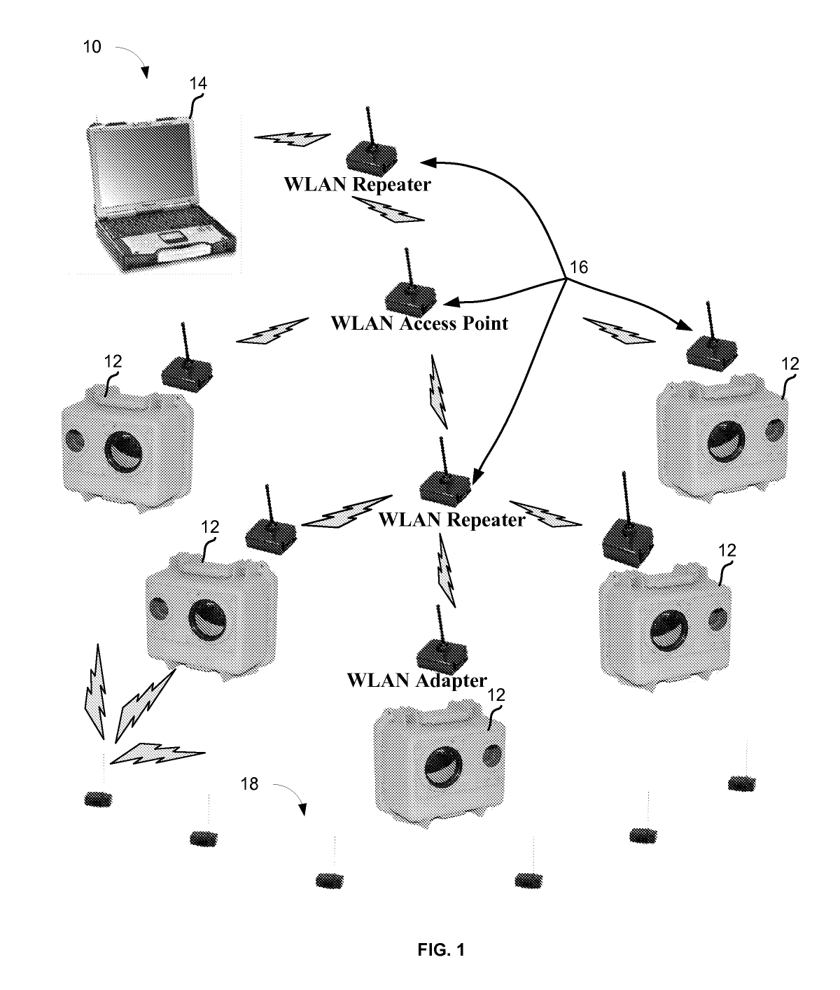

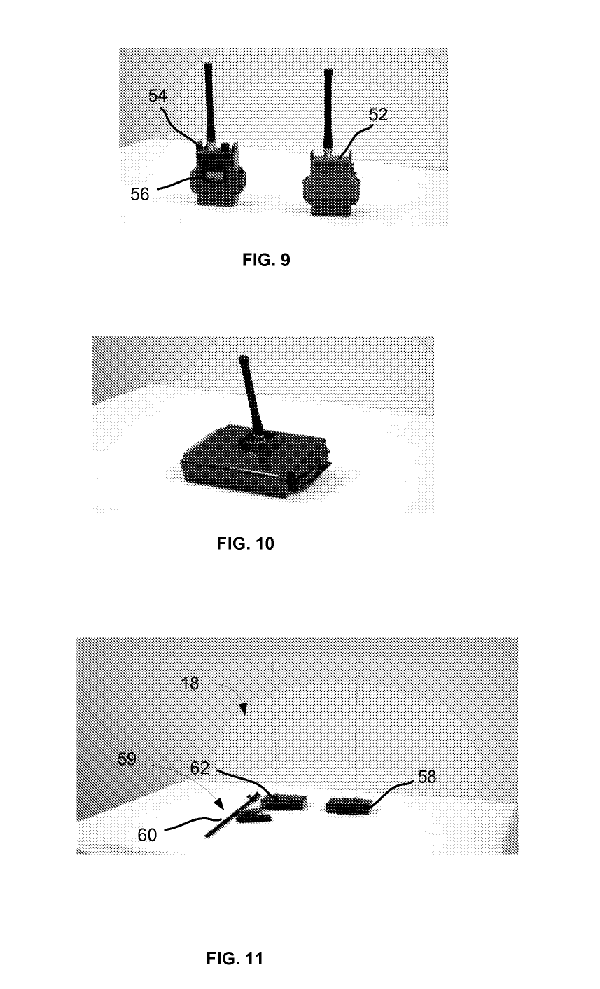

The present invention provides a manportable remote video surveillance, observation, monitoring and confirming sensor system 10. Referring now to the drawings, and initially to FIG. 1, the manportable remote video surveillance system 10 consists of five (5) different major components: 1) camera module(s) 12, 2) a base station 14, 3) wireless network module(s) 16, 4) a Mini Intrusion Detection System® (MIDS) 18 and 5) a field monitor 20 (FIG. 9). The system described below integrates emerging technologies in a wireless network, night vision cameras and Unattended Ground Sensors (UGS). To increase battery life, a timer relay is integrated to turn off the camera/transceiver between detection alerts.

Leveraging wireless network technology, video and audio can be transmitted over a secure local area network. Additionally, commercially available viewing software allows an operator to view/record transmissions (video and/or audio) from several cameras simultaneously on one computer, e.g., a laptop, a Personal Computer (PC) or a video monitoring system.

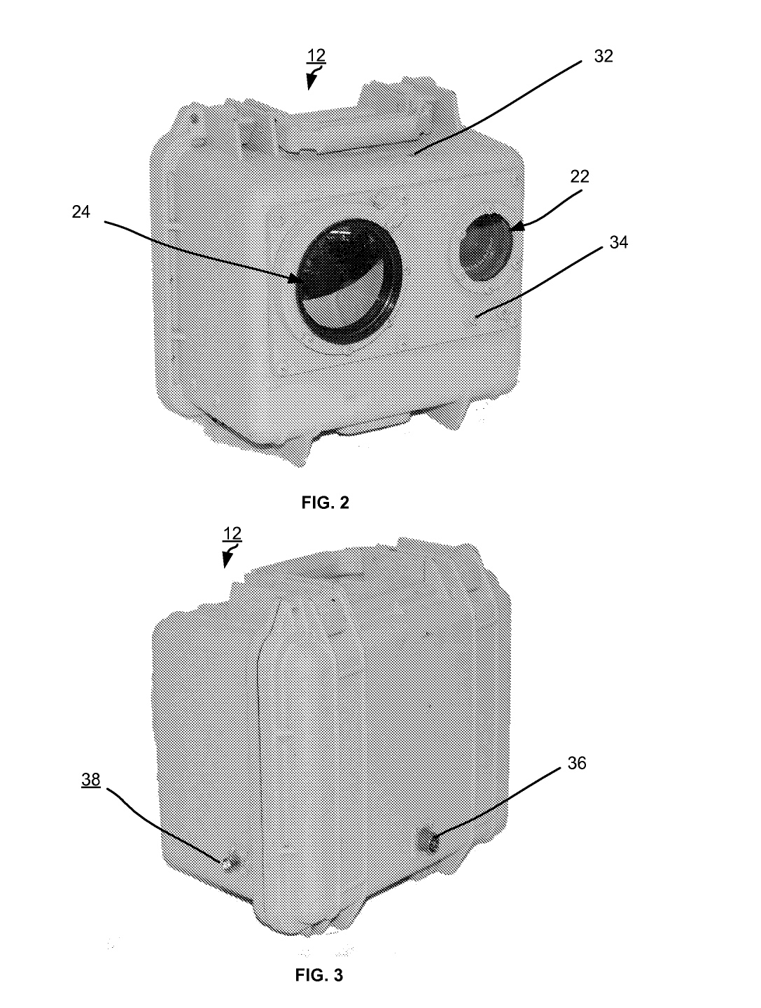

Each of the camera modules 12 have a dual camera design, during daytime conditions the color CCD camera 22 is selected or a forward looking infrared imager 24 (7 μm-12 μm) for nighttime conditions with zero illumination. The appropriate day/night camera is selected automatically with a photocell resister 32 (FIG. 2). This system 10 will then transmit automatically near real time video back to the base station 14. The system 10 can also be used solely as an observation device and can be turned on remotely. Total wake up time from UGS or Operator activation to receiving live video is less than 25 seconds. This system is designed for an outdoor environment and is camouflaged to meet the surrounding conditions. The laptop based base station 14 can be used to view the near real time video and record in a digital format for further reachback transmissions. The base station 14 may also be operated unmanned and can record and label each event to be reviewed by the operator at his/her discretion. The system is manportable and can be easily deployed.

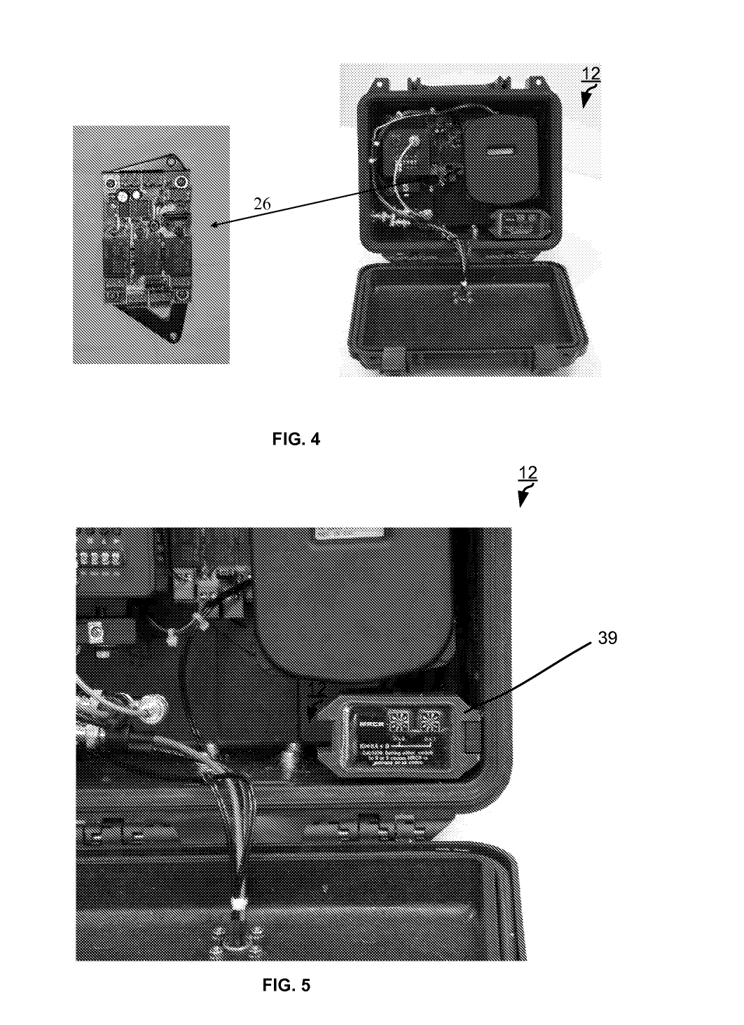

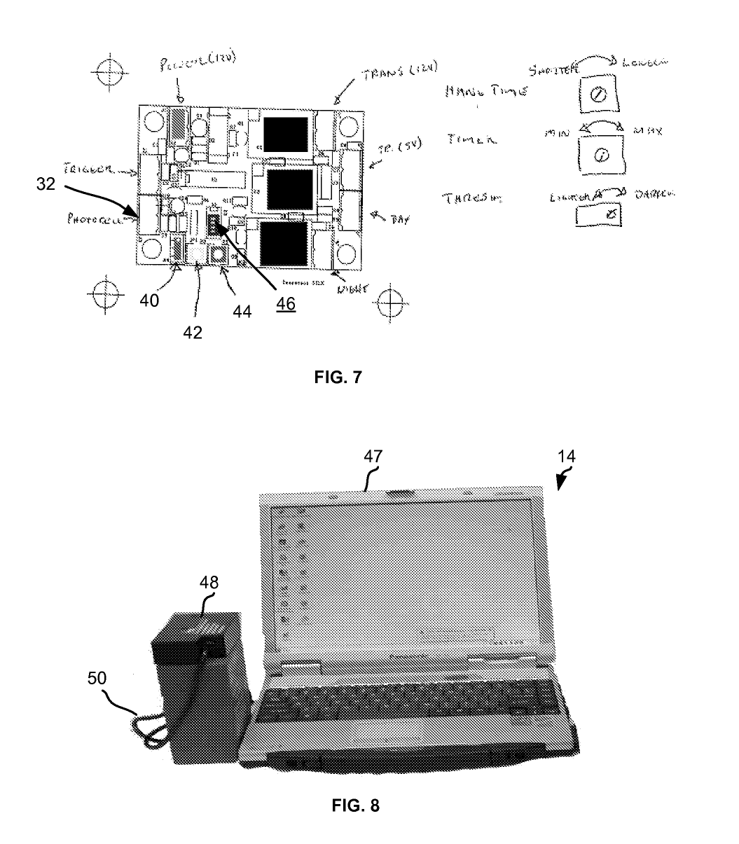

With reference to FIGS. 2-5, a camera module 12 is illustrated. The camera module includes; a day camera 22, a night camera 24, a control/distribution printed wiring board 26 (FIG. 7), power control printed wiring board 28 (FIG. 4), a MIDS receiver 30 (FIG. 5), photo diode 32, D-Link® IP encoder printed circuit board (internal) with microphone 34. The camera module also includes a power input connector 36 and a video monitor connector 38. The camera module compresses, encodes and transmits video and audio digitally where multiple cameras can be monitored, controlled and recorded simultaneously. The camera module may be camouflaged, as appropriate, to blend in with the local surroundings and emplaced to watch over an identified area of interest.

The day camera 22 may include, inter alia, a dual color and black and white camera with a quarter inch CCD, an optical and digital zoom, and auto focus, for example, a Watec LCL-187 security camera. The specifications of the camera are defined by the manufacture and for brevity are hereby incorporated by reference. The night camera 24 may include, inter alia, a 7 μm-12 μm infrared imager, fixed focus, auto gain and level and a field of view of 12 degrees by nine degrees (12°×9°), and a 75 mm lens, for example, a Raytheon 300D Series thermal sensor. The specifications of the camera are defined by the manufacture and for brevity are hereby incorporated by reference. One skilled in the art will understand that the lens can be changed to increase or decrease field of view.

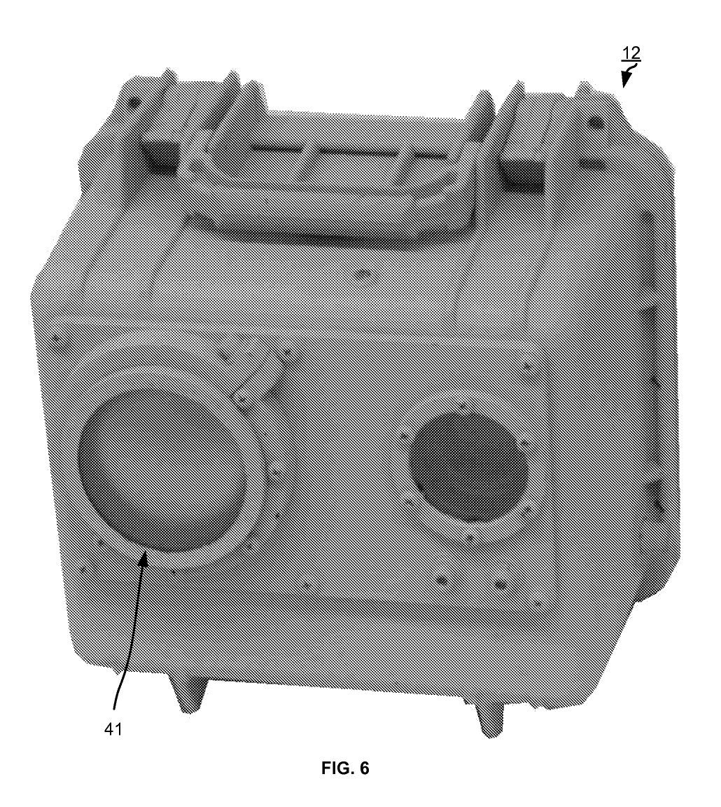

The camera module 12 may include an anti-reflective filter 41 (FIG. 6) to reduce the glare from the sun off the night camera lens to prevent the system from being compromised or detected by the enemy. The filter can be installed or removed much like a lens cap. The filter however does reduce the detection range of the night camera 24 by approximately 10 percent. The filter is made of a polypropylene material.

Referring now to FIG. 7, a camera module printed circuit board (PCB) 26 is illustrated. Inside the camera module is the camera module PCB with the purpose of power distribution to all of the sub-assemblies. The PCB 26 can be configured to turn ON or OFF remotely or be triggered ON by the Unattended Ground Sensors (UGS) with a timer. A technician can make the following adjustments to meet his/her mission profile. The PCB depicted in FIG. 4 shows three potentiometers, a top pot 40 is the photocell sensitivity (20 turn), a middle pot 42 is the hang time (single turn), this pot delays the switch over time up to 5 minutes to ignore sudden light changes, and a bottom pot 44 is a timer pot, it adjust the duration of a transmitter.

The photocell 32 on each of the camera modules 12 is controlled through 2 potentiometers located on the PCB inside each camera housing; this allows each camera to have different photocell settings. A color-coded schematic (not shown in color) with notes for the PCB is located between the day and night camera mounts inside the camera module.

Pot 40 (GREEN) controls the photocell's lighting “threshold” which causes the photocell resistor relay to switch between the day and the night camera. Ideally, this pot would be adjusted while the photocell 32 is on, when the photocell hang time is set to 0, the photocell 32 is unobstructed, and the lighting conditions for the environment are at the point where the sensor should switch between day and night modes (normally either dusk or dawn).

Turning the pot 40 clockwise will lower the “threshold” or cause the switchover to occur when it is darker outside, while turning the pot counter-clockwise will increase the “threshold” or cause the switchover to occur when it is brighter outside. It is recommended that the “hang time” is set to 0 while the “threshold” is adjusted.

Pot 42 (YELLOW) controls the “hang time” of the photocell. A short hang time will cause the camera module 12 to switch between the day camera 22 and the night camera 24 as soon as light conditions change, while a long hang time will require the camera module's photocell to receive sustained input that the lighting conditions have changed, before the camera module switches between day and night modes. For example, with a short hang time, someone's shadow passing over the photocell 32 briefly may cause the camera module to switch from day to night, even though it is still day time.

Turning the pot clockwise will increase the “hang time”, while turning counter-clockwise will decrease the “hang time”.

The timing cycle and triggering behavior of all cameras is controlled through a dip switch 46 and a potentiometer; once again this allows each camera to have different triggering settings.

The dip switch 46 (BLUE) controls a trigger behavior. The switch labeled “1” controls trigger behavior. If this switch is “ON”, the selected camera will toggle either ON or OFF when its MIDS ID is clicked. If this switch is “OFF”, the selected camera will turn on for a preset amount of time and then turn itself off.

The switch labeled “2” controls the timing range and only matters when switch “1” is “OFF”. When switch “2” is “ON”, the time will range from 5-55 minutes and when it is “OFF” the time will range from 0-5 minutes.

Switches “3” and “4” do not control anything.

Pot 44 (RED) controls the timing cycle. Once again, this pot only matters if switch “1” is “OFF”. A screw driver can be used to turn the pot in order to adjust the time a selected camera remains “ON” before turning itself off.

As mentioned earlier, this pot ranges from 0-5 minutes if switch “2” is “ON” and 5-55 minutes if switch “2” is “OFF”. Turning the pot 44 clockwise will increase the time while turning counter-clockwise will decrease the time. In most cases, turning the pot a quarter-turn is all that is needed. Thus, the camera module 12 uses a power management circuit that uses milli-watts of energy during time of non-activity at concern points of interest.

The base station 14 (FIG. 8) includes a laptop 47, a battery 48 and a battery adaptor 50. The laptop is shown with a voltage adaptor for a BB2590/U battery. Although a battery 48 is shown. It will be understood by those with ordinary skill in the art that a solar panel or internal rechargeable military grade battery could be used as well to supply power. The laptop is WI-FI compatible with an internal wireless 802.11 g card, for example. Program viewing software is installed on the laptop for the WI-FI encoder used in the camera module 12. Examples of the application software required to monitor system include Installation Wizard, IP Surveillance and IP Playback all from D-Link Inc.

Referring now to FIG. 9, a Qual-Tron Inc. MIDS Remote Control Transmitter (MRCT) 52 is illustrated. The MRTC 52 is used to turn the system 10 “ON” from anywhere with in line-of sight of the deployed system or repeater. The MRTC 52 uses two (2) each 9.0 Volt batteries for power (not shown).

Also illustrated in FIG. 9 is a Hand Held Receiver (MPDM) 54. The Hand held receiver 54 is used to receive and display (real time) the ID code number of any activated transmitter on an LCD display 56.

Refering now to FIG. 10, a wireless module representing the components of the wireless network 16 are illustrated. The wireless network 16 can consist of an access point (one or more), a repeater (one or more), an adapter (one or more), a wireless bridge, and a wireless router or the like, that are compatible with transmitting and receiving video and/or audio transmissions as is known by those with ordinary skill in the art. The components are configured, for example, to be a secure wireless network using TCP/IP protocols and IEEE 802.11 wireless standards, e.g., 802.11a, 802.11b, 802.11g, 802.11n or the like. The security may be wired equivalent privacy (WEP), Wi-Fi Protected Access (WAP) or the like.

With reference to FIG. 11, two (2) types of MIDS Unattended Ground Sensors (UGS) 18 are illustrated. The two (2) types of ground sensors used include; a Mini Seismic Intrusion Detector (MSID) sensor 58 and a Passive Infrared (IR) Sensor (PIRH) 60 with MIDS transmitter 62. The sensors are used to activate the camera modules 12.

The seismic sensor 58 is “triggered” by detections of ground vibrations. The seismic sensor 58 can sense personnel at 10 to 30 meters, wheeled vehicles at 30 to 50 meters, and tracked vehicles at 50 to 100 meters. The seismic sensor 58 uses two (2) each 9.0 Volt Alkaline batteries for power for up to 4 to 8 months (not shown).

The IR sensor 59 is “triggered” by detection of temperature changes within its 5-degrees (°) field-of-view. The IR sensor emplacement consists of the Passive Infrared Head (PIRH) 60 and Transmitter MXMT 62. The sensor uses one (1)-two (2) each 9.0 Volt Alkaline batteries for power for up to 4 to 8 months (not shown).

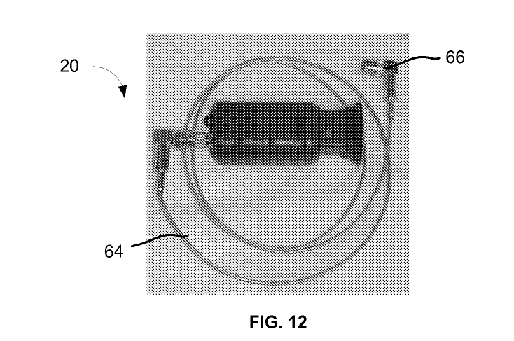

Referring now to FIG. 12, the Field Monitor 20 is illustrated. The Field Monitor 20 is a small hand held battery powered video monitor that is used to view and assess the video output of the camera module 12. The Field monitor 20 can be connected to the camera module 12 via a video cable 64 with a video connector 66 compatible with the video connector 38 on the camera module.

In operation, the MIDS sensor unit(s) 58 and 59 cue and activate the camera module(s) 12 to turn “ON” and transmit audio/video to the Base Station 14 and/or WI-FI server. The Base Station module 14 will display and record the event on the laptop computer 47.

Once the system is deployed and checked out for proper operation it will automatically go into a “sleep” or alert mode. It will activate when any MIDS ground sensor 58 and 59 unit detects an intrusion or when the operator remotely activates it with the MIDS transmitter 52. This feature can be disabled to have the selected camera operate continuously.

One or more MIDS sensors 58 and 59, such as the passive infrared 60 and/or seismic 58, are placed along the avenue(s) of approach to provide activation of one or more of camera module(s) 12. When any MIDS sensor detects an intrusion (movement), that MIDS sensor transmits a signal. All of the deployed camera module's MIDS receivers receive the signal and activate the appropriate camera as determined by the photocell 32 incorporated within the module. At the same time, the video encoder board begins to transmit compressed video, e.g., MPEG4, from all selected cameras. The video is received at the Base Station 14 or through the wireless LAN 16. The incoming near-real time video is automatically stored in memory of the computer and it can also be viewed on the laptop screen.

The duration of the RF transmission can be preset for a preferred period of time from ten (10) seconds to 1 hour. The unit is initially preset for one (1) minute. This arbitrary time period is selected to minimize power consumption, thus extending battery life. At the end of the preset transmission time, the system 10 shuts down and returns to a dormant (sleep) state until the next activation.

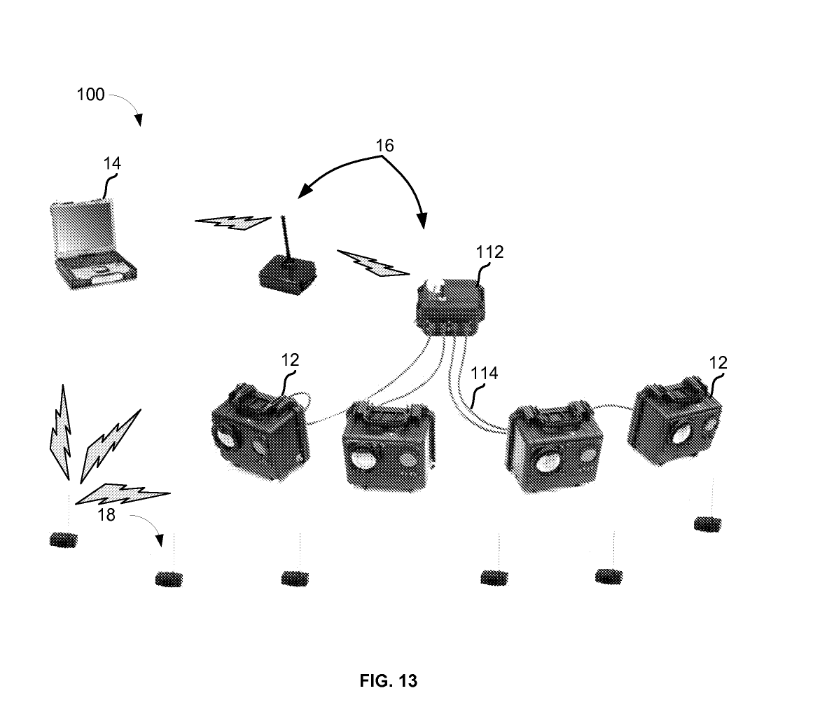

An alternative remote monitoring system 100 is illustrated in FIG. 13. In this system, the cameras are physically and electrically coupled to the transmitter/node module with antenna 112 via video cables 114. The Transmitter/Node module 112 is placed in a central proximity position with respect to the location and number of camera modules 12 deployed. The transmitter/node module 112 is also camouflaged, as appropriate, to blend in with the local surroundings.

The Transmitter/Node module 112 includes; two (2) batteries (not shown) that supply electrical power for the Transmitter/Node module and the camera module(s) 12, a multi-video board for the use of more than one camera module, the video transmitter for the video transmission link to the base station, and an antenna for the transmitter.

The remaining components are as described above with regard to manportable remote video surveillance, observation, monitoring and confirming sensor system 10.

Although the invention has been shown and described with respect to certain preferred embodiments, it is obvious that equivalent alterations and modifications will occur to others skilled in the art upon the reading and understanding of this specification and the annexed drawings. In particular regard to the various functions performed by the above described components (assemblies, devices, sensors, circuits, etc), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A video surveillance system comprising:
at least one camera module electrically coupled to at least one Mini Intrusion Detection System® (MIDS), and
a base station electrically coupled to the at least one camera module to provide surveillance, monitoring, observation and confirmation of a motion detected by the MIDS.

2. The video surveillance system as recited in claim 1, wherein the at least one camera module is electrically coupled to the at least one MIDS by a wireless network.

3. The video surveillance system as recited in claim 2, wherein the wireless network is an 802.11 standard wireless network.

4. The video surveillance system as recited in claim 1, wherein the base station is electrically coupled to the at least one camera module by a wireless network.

5. The video surveillance system as recited in claim 4, wherein the wireless network is an 802.11 standard wireless network.

6. The video surveillance system as recited in claim 1, wherein the camera module compresses, encodes and transmits video and audio digitally.

7. The video surveillance system as recited in claim 1, wherein the camera module includes a day camera and a night camera and the system selects between the day camera and the night camera based on the environmental conditions.

8. The video surveillance system as recited in claim 1, wherein a field monitor is electrically coupled to the at least one camera module to view and assess a video output of the at least one camera module.

9. The video surveillance system as recited in claim 1, wherein the at least one camera module includes a day camera and a night camera and a photocell and circuit board to select therebetween.

10. The video surveillance system as recited in claim 9, wherein the at least one camera module includes an anti-reflective filter to reduce glare.

11. The video surveillance system as recited in claim 1, wherein a timer relay is integrated to turn off the camera module between detection alerts.

12. A video surveillance system comprising:
at least one camera module electrically coupled to at least one Mini Intrusion Detection System® (MIDS), and
a base station electrically coupled to the at least one camera module to provide surveillance, monitoring, observation and confirmation of a motion detected by the MIDS,
wherein the camera module is hardwired to a transmit receiver and the transmit receiver is wirelessly connected to the base station.

13. The video surveillance system as recited in claim 12, wherein the at least one camera module is electrically coupled to the at least one MIDS by a wireless network.

14. The video surveillance system as recited in claim 13, wherein the wireless network is an 802.11 standard wireless network.

15. The video surveillance system as recited in claim 12, wherein the camera module compresses, encodes and transmits video and audio digitally.

16. The video surveillance system as recited in claim 12, wherein the camera module includes a day camera and a night camera and the system selects between the day camera and the night camera based on the environmental conditions.

17. The video surveillance system as recited in claim 12, wherein a field monitor is electrically coupled to the at least one camera module to view and assess a video output of the at least one camera module.

18. The video surveillance system as recited in claim 12, wherein the at least one camera module includes a day camera and a night camera and a photocell and circuit board to select therebetween.

19. The video surveillance system as recited in claim 18, wherein the at least one camera module includes an anti-reflective filter to reduce glare.

20. The video surveillance system as recited in claim 12, wherein a timer relay is integrated to turn off the camera module between detection alerts.
